(19) United States
(12) Patent Application Publication
(10) Pub. No.: US 2023/0158575 A1
(43) Pub. Date: May 25, 2023

(54) LIQUID METAL EJECTOR BUOYANT SENSING SYSTEM AND METHODS THEREOF

(71) Applicant: XEROX CORPORATION, Norwalk, CT (US)

(72) Inventors: Seemit Praharaj, Webster, NY (US); Douglas K. Herrmann, Webster, NY (US); Jason M. LeFevre, Penfield, NY (US)

(73) Assignee: XEROX CORPORATION, Norwalk, CT (US)

(21) Appl. No.: 17/534,040

(22) Filed: Nov. 23, 2021

(51) Int. Cl. B22F 12/53; B22D 23/00; B22F 10/22; B22F 12/90; B33Y 10/00; B33Y 30/00; B33Y 50/02

(52) U.S. Cl. CPC B22F 12/53; B22D 23/003; B22F 10/22; B22F 12/90; B33Y 10/00; B33Y 30/00; B33Y 50/02

(57) ABSTRACT

A metal ejecting apparatus is disclosed. The metal ejecting apparatus includes a nozzle orifice in connection with the inner cavity and configured to eject one or more droplets of the liquid metal printing material, a float in contact with a surface of the liquid metal printing material, where the float is buoyant within the liquid printing material, and a filament attached to the float on a first end and attached to a level sensing system on a second end. The level sensing system may include an ultrasonic sensor, a visual sensor, a mechanical force sensor, a laser sensor, or a combination thereof. A method of sensing and controlling a level of liquid printing material in a metal jetting apparatus is also disclosed.

### TECHNICAL FIELD

The present teachings relate generally to liquid ejectors in drop-on-demand (DOD) printing and, more particularly, to a buoyancy-based level sensing system and methods for use within a liquid metal ejector of a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, particularly one that prints a metal or metal alloy, ejects a small drop of liquid aluminum alloy when a firing pulse is applied. Using this technology, a 3D part can be created from aluminum or another alloy by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

In MHD printing, a liquid metal is jetted out through an exit orifice of a nozzle of the 3D printer onto a substrate or onto a previously deposited layer of metal. A printhead used in such a printer is a single-nozzle head and includes several internal components within the head which may need periodic replacement. In some instances, a typical period for nozzle replacement may be an 8-hour interval. During the liquid metal printing process, the aluminum and alloys, and in particular, magnesium containing alloys, can form oxides and silicates during the melting process in the interior of the pump. These oxides and silicates are commonly referred to as dross. The buildup of dross is a function of pump throughput and builds continuously during the print process. In addition to being composed of a combination of aluminum and magnesium oxides and silicates, the dross may also include gas bubbles. Consequently, the density of the dross may be lower than that of the liquid metal printing material and the dross may build at the top of the melt pool, eventually causing issues during printing. Certain DOD printers use, for example, a non-contact red-semiconductor laser sensor, operating at an approximate wavelength of 660 nm, for measuring the melt pool height during printing. This is commonly referred to as a level-sensor. Dross accumulation while printing impacts the ability of the level-sensor to accurately measure the molten metal level of the pump and may lead to prematurely ending the print job. This may also cause the pump to erroneously empty during printing, thereby ruining the part. Dross plugs may also grow within the pump causing issues with the pump dynamics resulting in poor jet quality and additional print defects, such as the formation of satellite drops during printing. The dross could potentially break apart and a chunk of this oxide falls into the nozzle resulting in a clogged nozzle orifice. When the level sense signal “drops out,” this can cause a catastrophic failure condition, leading to printer shut down, requiring clearing or removal of the dross plug, replacing the print nozzle, and beginning start-up procedures again.

Thus, a method of and apparatus for level sense control in a metal jet printing drop-on-demand or 3D printer is needed to provide longer printing times and higher throughput without interruption from defects or disadvantages associated with dross build-up.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A metal ejecting apparatus is disclosed. The metal ejecting apparatus includes a nozzle orifice in connection with the inner cavity and configured to eject one or more droplets of the liquid metal printing material, a float in contact with a surface of the liquid metal printing material, where the float is buoyant within the liquid printing material, and a filament attached to the float on a first end and attached to a level sensing system on a second end.

Implementations of the metal ejecting apparatus include a hollow float, where a density of the float is less than a density of the liquid metal printing material, or where the float may include boron nitride. The float may be non-wetting when in contact with the liquid metal printing material. The float may be resistant to high temperature. The filament may be under tension. The filament may include a material that may be resistant to high temperature and non-wetting when in contact with the liquid metal printing material. The filament may include an indicating feature in one or more locations along a length of the filament. The indicating feature is configured to alert the level sensing system of a low level of liquid metal printing material. The indicating feature is configured to alert the level sensing system of a sufficient level of liquid metal printing material. The level sensing system may include an ultrasonic sensor, a visual sensor, a mechanical force sensor, a laser sensor, or a combination thereof.

Another exemplary metal ejecting apparatus is disclosed. The metal ejecting apparatus may include a nozzle orifice in connection with the inner cavity and configured to eject one or more droplets of the liquid metal printing material, a float in contact with a surface of the liquid metal printing material where the float is buoyant within the liquid printing material, a filament which may include an indicating feature, attached to the float on a first end, and attached to a level sensing system. The metal ejecting apparatus may include where the level sensing system is configured to receive a signal from the indicating feature.

Implementations of the metal ejecting apparatus may include where the indicating feature is configured to alert the level sensing system of a low level of liquid metal printing material, and the indicating feature is configured to alert the level sensing system of a sufficient level of liquid metal printing material. The level sensing system may include an ultrasonic sensor, a visual sensor, a mechanical force sensor, a laser sensor, or a combination thereof.

A method of sensing and controlling a level of liquid printing material in a metal jetting apparatus is disclosed. The method includes placing a buoyant float onto a surface of a liquid printing material held within an inner cavity of the metal jetting apparatus, receiving a first signal indicative of a vertical position of the buoyant float within the inner cavity of the metal jetting apparatus, and sending a second signal to a printing material feed system.

Exemplary implementations of the method of sensing and controlling a level of liquid printing material in a metal jetting apparatus may include where receiving the first signal is completed with a level sensing system may include an ultrasonic sensor, a visual sensor, a mechanical force sensor, a laser sensor, or a combination thereof. The method of sensing and controlling a level of liquid printing material in a metal jetting apparatus may include adding printing material from the printing material feed system when the first signal indicates that the vertical position of the buoyant float denotes an insufficient level of liquid printing material held within the inner cavity of the metal jetting apparatus. The method of sensing and controlling a level of liquid printing material in a metal jetting apparatus may include stopping an addition of printing material from the printing material feed system when the first signal indicates that the vertical position of the buoyant float denotes a sufficient level of liquid printing material held within the inner cavity of the metal jetting apparatus. The method of sensing and controlling a level of liquid printing material in a metal jetting apparatus may include heating a solid printing material held within the inner cavity of the metal ejecting apparatus, thereby causing the solid printing material held to change to a liquid within the metal ejecting apparatus.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid ejector jet of a 3D printer (e.g., a MHD printer and/or multi-jet printer), according to an embodiment.

FIG. 2 is a side cross-sectional views of a liquid ejector jet contaminated with dross, according to an embodiment.

FIGS. 3A-3C are a series of side cross-sectional views of liquid ejector jet with a buoyant level sensing system, illustrating operative steps of the level sensing system, according to an embodiment.

FIGS. 4A-4B are a series of side cross-sectional views of a buoyant level sensing system for a liquid ejector jet, illustrating operative steps of the level sensing system, according to an embodiment.

FIG. 5 is a flowchart illustrating a method of level sensing in a liquid ejector jet of a metal jetting printer, according to an embodiment.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

In metal jet printers employing a drop-on-demand printing methodology and technology, a small drop, also referred to as a droplet, of liquid aluminum alloy or other metal is ejected when a firing pulse is applied. Using this technology, a three-dimensional (3D) part can be created from aluminum alloy or another metal by ejecting a series of drops which bond together to form a continuous part. The print-head, or metal ejector jet, used in exemplary printers is a single-nozzle head and certain internal components within the head need periodic replacement. A typical period for nozzle replacement may be on the order of an 8-hour interval. During the metal jet printing process the aluminum and components of the alloys, in particular magnesium, can form oxides during the melting process on the inlet and in the inner cavity of the pump, which is commonly referred to as “dross.” This dross builds up in the inner cavity and other areas of the ejector pump during printing and is a function of printing material throughput through the pump. The dross, in the case of aluminum printing material, is a combination of aluminum oxide, magnesium oxide, aluminum and gas bubbles. The dross builds in the top of the melt pool that resides in the metal ejector pump and causes issues during printing. Exemplary printing systems employ a red-semiconductor laser (660 nm wavelength) non-contact sensor for measuring the melt pool height during printing, and thus is an effective level sensor for the metal jet printing system. Dross accumulation while printing impacts the ability of the level sensor to accurately measure the molten metal level of the pump and leads to prematurely ending the print job. When the level sense signal “drops out” it leads to shutting down the machine, clearing or removing the dross plug, replacing the print nozzle, and beginning the start-up procedure again. This may result in an incomplete part or premature shutdown of a printing operation.

Exemplary embodiments of the present disclosure include a level sensing system for a liquid ejector using a buoyant ceramic float suspended into the upper pump portion of the liquid metal ejector for continuous monitoring of the height of the melt pool. The buoyant construction of the float would constrain it to be located at the top of the melt pool irrespective of the composition of the melt pool. For example, if there were dross or other contamination in the melt pool, the float mechanism would remain operational. The vertical translation of the float is captured externally and converted to a pool height via a continuous line. A connected tensioner apparatus may be used to maintain a constant tension in the lines leading up to the float, and therefore, the height of the top level of the melt pool is maintained within the nominal range via a closed loop system connecting the aluminum wire feed and the level sensing systems.

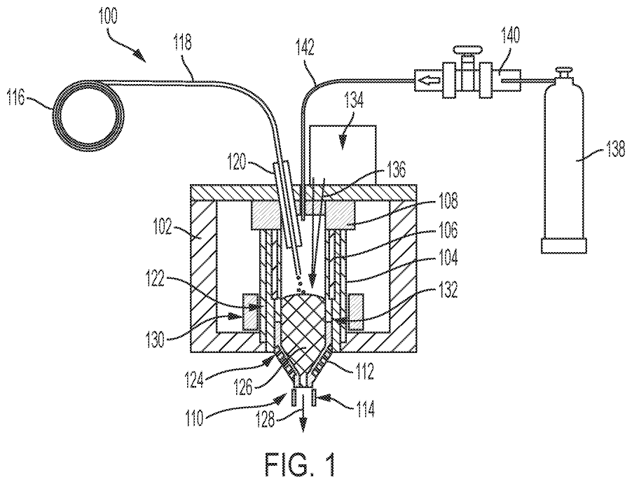

FIG. 1 depicts a schematic cross-sectional view of a single liquid metal ejector jet of a 3D printer (e.g., a MHD printer and/or multi-jet printer), according to an embodiment. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity or an inner cavity). A printing material 126 may be introduced into the inner volume 132 of the ejector 104. The printing material 126 may be or include a metal, a polymer, or the like. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, also referred to as a nozzle orifice or exit orifice, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate, not shown herein, that is positioned proximate to (e.g., below) the nozzle 110. The ejected drops 128 may land on the substrate and solidify to produce a 3D object. The 3D printer 100 may also include a substrate control motor that is configured to move the substrate while the drops 128 are being jetted through the nozzle 110, or during pauses between when the drops 128 are being jetted through the nozzle 110, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another embodiment, the ejector 104 and/or the nozzle 110 may be also or instead be configured to move in one, two, or three dimensions. In other words, the substrate may be moved under a stationary nozzle 110, or the nozzle 110 may be moved above a stationary substrate. In yet another embodiment, there may be relative rotation between the nozzle 110 and the substrate around one or two additional axes, such that there is four or five axis position control. In certain embodiments, both the nozzle 110 and the substrate may move. For example, the substrate may move in X and Y directions, while the nozzle 110 moves up and/or down in a Y direction.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another embodiment, the gas may be or include nitrogen. The gas may include less than about 10% oxygen, less than about 5% oxygen, or less than about 1% oxygen. In at least one embodiment, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one embodiment, the enclosure 102 may be hermetically sealed. In another embodiment, the enclosure 102 may not be hermetically sealed. In one embodiment, the ejector 104, the heating elements 112, the power source, the coils, the substrate, additional system elements, or a combination thereof may be positioned at least partially within the enclosure 102. In another embodiment, the ejector 104, the heating elements 112, the power source, the coils, the substrate, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design embodiments.

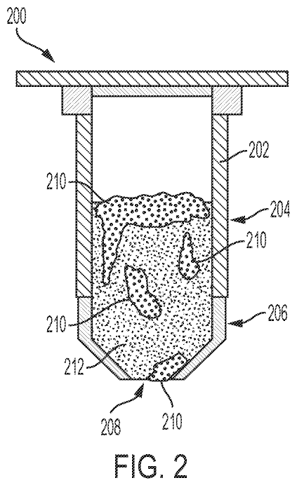

FIG. 2 is a side cross-sectional views of a liquid metal ejector contaminated with dross, according to an embodiment. The ejector 200 is shown, which further defines an outer wall or inner cavity 202 of the ejector, an upper pump area 204, a lower pump area 206, and an outlet nozzle 208. Within the inner cavity 202 of the ejector 200 is further shown a molten printing material 212 and schematic of dross 210 build-up within and on top of the printing material 212. The dross 210, in certain embodiments, and dependent upon which printing material is used in the printing system, is a combination of aluminum oxides, magnesium oxides, and silicates. The dross 210 may also include gas bubbles. In certain embodiments, the dross 210, may include additional materials or contaminants, such as oxides and silicates of aluminum (Al), calcium (Ca), magnesium (Mg), silicon (Si), iron (Fe), or possibly air bubbles or other contaminants containing sodium (Na), potassium (K), sulfur (S), chlorine (Cl), carbon (C) or combinations thereof, The dross 210 typically builds towards the top of the melt pool that resides near the upper pump area 204 in the ejector 200 and may potentially cause issues during printing. Dross 210 accumulation may potentially impact the ability of the aforementioned level sensor that measures the molten metal level inside the ejector 200. An erroneous signal for the level sensor system can cause the pump to empty during printing, which could result in ruining the part being printed. One or more dross 210 “plugs” may also have a propensity to grow within the pump, which in turn may cause issues with the pump dynamics. Interruptions or issues in pump dynamics may further result in poor jet quality and the formation of satellite drops during printing. A satellite drop may refer to a drop with only a fraction of the volume of the main drop which can be unintentionally formed during the jetting of a main drop. For example, a physical occlusion at the nozzle is one potential cause resulting in the formation of a satellite drop. In certain embodiments or instances, the dross 210 could also potentially break apart, and a portion of this fragmented dross or oxide may fall into the nozzle 208 resulting in a clogged nozzle 208. Any failure arising from the accumulation of dross 210 has the tendency to be catastrophic, which could lead to necessitating a shutdown of the printer, having to clear or remove the dross 210 plug, replacing the print nozzle, beginning start-up again, or combinations thereof. It should be noted that additional features or elements of the printer or ejector system are not depicted in FIG. 2 for purposes of clarity.

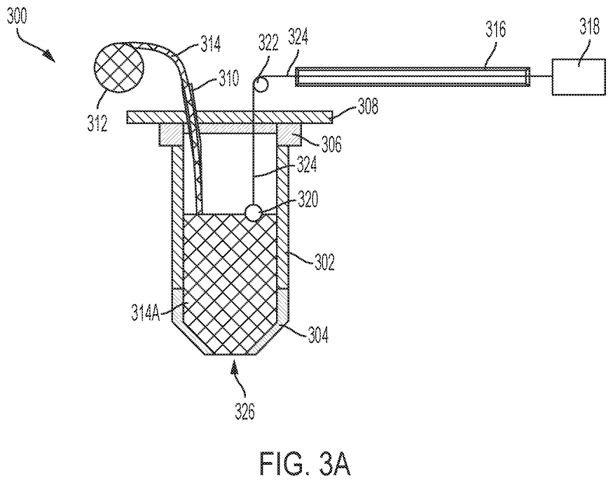

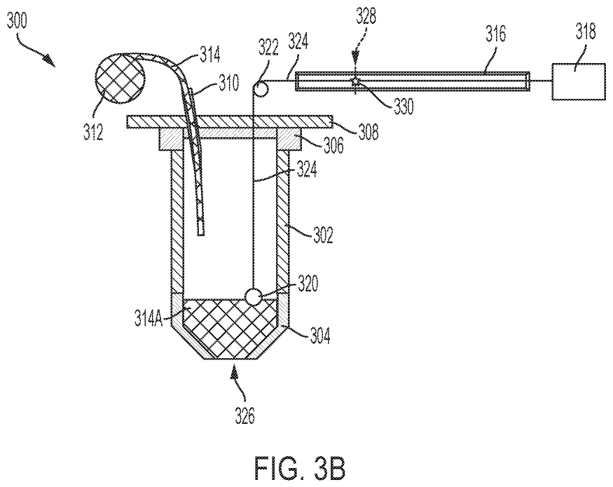

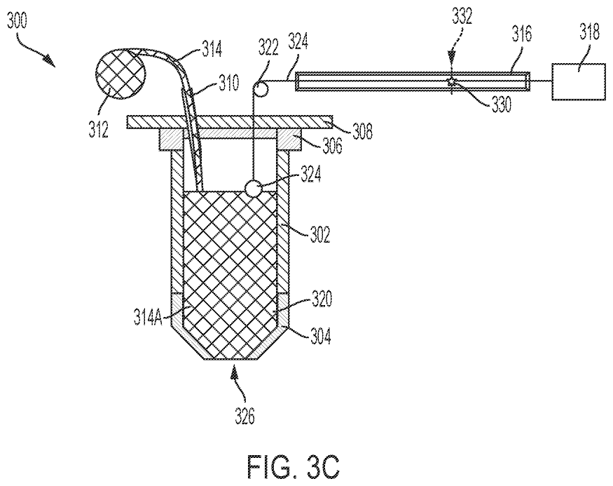

FIGS. 3A-3C are a series of side cross-sectional views of liquid ejector jet with a buoyant level sensing system, illustrating operative steps of the level sensing system, according to an embodiment. A liquid ejector jet with buoyant level sensing system 300 is depicted in FIG. 3A, with a float 320 shown at a height representative of what might be observed during a normal operation of the liquid ejector jet having a buoyant level sensing system 300. The liquid ejector jet with buoyant level sensing system 300 includes an upper pump 302 segment and a lower pump 304 segment, which can be press fit together to form an ejector body. The liquid ejector jet further includes an ejector enclosure 306 covering the upper pump 302 segment and an overall cover 308, wherein the cover 308 further defines an inlet 310 port for the introduction of a printing material 314 into an inner cavity defined by the structure formed by the upper pump 302 and the lower pump 304. A printing material feed 312 system is located external to the ejector body formed by the upper pump 302 segment and lower pump 304 segment. The printing material feed and associated mechanism is configured to feed a wire printing material 314 into the inlet 310 port and into an inner cavity formed by the upper pump 302 segment and lower pump 304 segment. As the ejector body is heated, referenced previously, the wire printing material 314, which is a solid, is heated such that it transforms into a liquid printing material 314A. Certain embodiments of such an ejector may have the printing material supply located internal to a housing that includes the liquid ejector. Furthermore, alternate embodiments may include other means of introduction of printing material, such as a powder feed system or other printing material introduction means known to those skilled in the art. Example printing materials which could be ejected using a liquid ejector according to embodiments described herein also include alloys of aluminum, copper, iron, nickel, brasses, naval brass, and bronzes. Silver and alloys thereof, copper and alloys thereof, metallic alloys, braze alloys, or combinations thereof may also be printed using liquid ejectors according to embodiments herein. On a surface of the liquid printing material 314A, a float 320 is illustrated, floating on the surface of the liquid printing material 314A. The float 320 is attached at a first end to a filament 324, which is held in place by and allowed to freely move about a pulley 322. The filament 324 is constrained within an external level sense system 316 and attached at a second end to tensioner 318, which holds the filament 324 at a consistent tension to counteract the force induced on the filament 324 by the combination of the downward force of gravity and the upward force of buoyancy. While not wishing to be bound by any particular theory, other forces may be acting on the force induced on the filament 324. The float 320 may be made from a hollow ceramic material, such as boron nitride, that has an external surface that is inert or non-wetting when in contact with a molten metal printing material or when in contact with a surface of the liquid metal printing material. In certain embodiments, the float may be constructed of a high-temperature resistant material such as a ceramic, graphite, or metal, coated with an inert surface coating, as long as the function of the float is preserved, i.e., the float is hollow, or is buoyant, or able to stay afloat when placed on a surface of a molten printing material or has a lower density than that of the molten printing material. In certain examples, a density of a molten aluminum printing material at a printing temperature of interest will be approximately between 2.6 and 2.8 g/cm³. Furthermore, the float and the wire or filament are inherently repellant or non-wetting to the molten aluminum alloy material or other printing material, either by coating or by the float or filament composition. One example material that is non-wetting or repellant is boron nitride. The filament 324 maintains under a constant tension on the float 320, such that the location and therefore the level of the float 320 may be accurately located. The filament 324 is made from a high-temperature resistant material, such as a ceramic fiber, metal braid, and the like. The filament material is resistant to high temperature and non-wetting when in contact with the liquid metal printing material. In the embodiment shown, the filament 324 follows a partially vertical path, winds around the pulley 322, and then proceeds along a horizontal path where the filament 324 passes freely through the external level sense system and is then attached to the tensioner 318. While the filament 324 may freely move through an internal path defined by the external level sense system 316, the path of the filament 324 is still constrained by the internal shape and path defined by the external level sense system 316. Certain embodiments of the liquid ejector jet with buoyant level sensing system 300 may feature an external level sense system 316 following an entirely vertical path or be oriented having a vertical component and a second portion oriented at an angle other than 90 degrees. In certain embodiments, the orientation may not be constrained to any particular orientation, as long the buoyant ceramic float can translate in a vertical path within the upper pump 302 area to be suspended into the upper pump 302 for continuous monitoring of the height of the melt pool and provide an indication of printing material 314A level.

FIG. 3B illustrates a side cross-sectional view of liquid ejector jet with a buoyant level sensing system 300, illustrating the operative step of the level sensing system, where a printing material level within the ejector is low. As shown in FIG. 3B, the level of liquid printing material 314A has been depleted to a low level, due to printing throughput, and thus the float 320 is lowered in concert with the lower level of the surface of the liquid printing material 314A upon which the float 320 floats. As the tensioner 318 attached to the filament 324 allows the float 320 to travel along with the level of the surface of the liquid printing material 314A, the filament 324 translates in position as well. As the filament 324 travels around the pulley 322, an indicator 330 on the filament 324 reaches a position within the external level sense system 316 consistent with a low level limit 328. As the float 320 and along with it the indicator 330 on the filament 324 reaches the low level limit 328, a signal is sent to the printing material feed 312 system to begin feeding additional printing material 314 into the inner cavity of the upper pump 302 area to replenish or fill the liquid ejector jet 300 with additional printing material 314. The indicating feature or indicator 330 on the filament 324 may be in one or more locations along a length of the filament 324. This indicator 330 is configured to alert the level sensing system 316 of a low level of liquid metal printing material 314A in an inner cavity of the liquid ejector jet. The indicating feature 330 is also configured to alert the level sensing system 316 of a sufficient level of liquid metal printing material 314A in an inner cavity of the liquid ejector jet. Once the printing material 314 is introduced into the inner cavity of the upper pump 302, the solid printing material 314 will be changed to a liquid printing material 314A by heating from the heaters in the liquid ejector jet 300 system, which are not shown in FIG. 3B. In certain embodiments, the external level sense system 316, indicator 330, and low level limit 328 may include a sensing componentry and protocol based on a tension or force measurement, ultrasonic-based measurement system, visual-based system, electrical-based system, laser-based system, or a combination thereof.

FIG. 3C illustrates a side cross-sectional view of liquid ejector jet with a buoyant level sensing system 300, illustrating the operative step of the level sensing system, where a printing material level within the ejector is filled to a sufficient level. As shown in FIG. 3C, the inner cavity of the upper pump 302 has been filled with the printing material 314 as was described previously in regard to FIG. 3B. As the inner cavity of the upper pump 302 is now refilled with liquid printing material 314A, the float 320 has been raised upward along with the rising surface of the liquid printing material 314A melt pool. The filament 324, being held under constant tension due to being attached to the tensioner 318 on the other end, slack in the filament 324 as it moves around the pulley 322 as the float 320 is raised, is taken up by the tensioner 318. As the indicator 330 on the filament 324 moves across the external level sense system 316 towards a upper level limit 332, the external level sense system 316 then sends a signal to the printing material feed 312 to stop or pause feeding printing material 314 into the upper pump 302 inner cavity. As printing operations continue, the sequence of general operative steps depicted in regard to FIGS. 3A-3C may repeat as necessary. Thus, an operable level of liquid printing material 314A may be maintained within the liquid ejector jet 300 and not be interrupted by the presence of dross or other system contaminants that may interfere known laser level sensing methods that rely on reflection or the reflective properties at a surface of the melt pool.

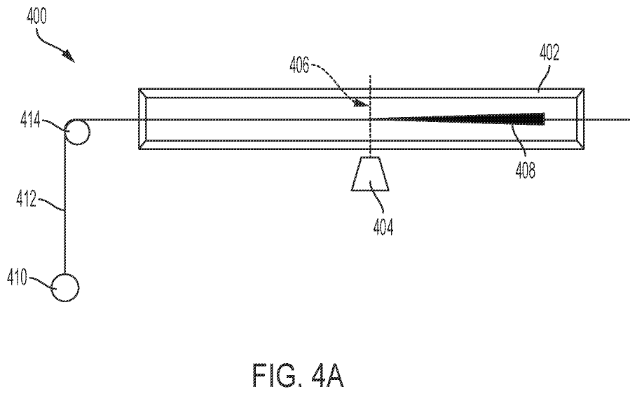

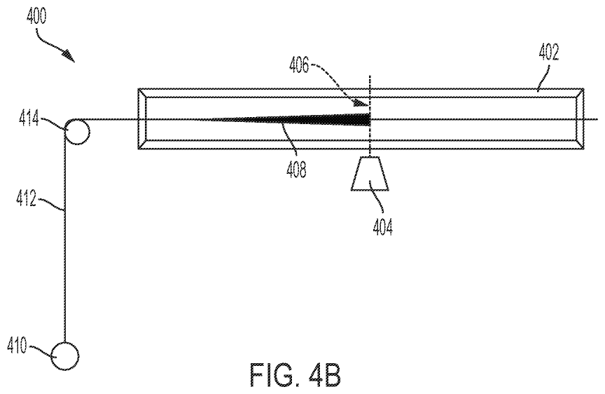

FIGS. 4A-4B are a series of side cross-sectional views of a buoyant level sensing system for a liquid ejector jet, illustrating operative steps of the level sensing system, according to an embodiment. FIG. 4A is a side cross-sectional view showing a partial buoyant level sensing system 400 for a liquid ejector jet. It should be noted that portions of the level sensing system 400 and of the ejector jet system are not shown herein for the purpose of clarity. The level sense system 400 includes an external level sense system 402 wherein a filament 412 travels freely throughout back and forth but is constrained to travel within the external level sense system 402. As a float 410 attached to the filament 412 at one end raises and lowers by virtue of the height or level of the melt pool of printing material within an inner cavity of an ejector jet. The float 410 is held in position at the surface of the melt pool, and is held under consistent tension by a tensioner, which is not shown here, and held over a melt pool by a pulley 414, over which the filament 412 passes. The filament 412 also has an indicator 408, which as shown is an increasing gradient flag or thickness increase affixed to a portion of the filament 412, such that when the indicator 408 passes through a detector path 406 detected by a detector 404, the detector 404 may send a signal to a printing material feed system based on the level of signal detected by the detector 404 and passed on to the printing material feed system. As shown in FIG. 4B, as the float 410 lowers further, which would correlate to a reduced level of printing material within an ejector jet inner cavity, the filament 412 moves along with the float 410, thus moving the indicator 408 to the left and therefore changes the signal received by the detector 404 from the indicator 408 on the filament 412. As shown in FIG. 4B, this would alert the detector 404 to send a signal to the printing material feed system to begin introducing printing material into the inner cavity of the ejector to begin filling the inner cavity with new printing material. The feeding of the printing material would continue until the indicator 408 was once again at the position shown in FIG. 4A, which alerts the printing material feed system to pause or stop feeding printing material in the inner cavity of the ejector jet. This sequence as described in regard to FIGS. 4A and 4B could continue to repeat for as long as necessary to complete a print job, without being interrupted by any contamination or dross build up within the inner cavity of the ejector jet.

The use of a buoyant ceramic float suspended into the upper pump for continuous monitoring of the height of the melt pool, constrained to be located at the top of the melt pool irrespective of the composition of either the float or the contamination or melt pool. Several conventional ceramics, due to their heat and corrosion resistant properties make ideal float materials. The vertical translation of the float is captured externally and converted to a pool height via a continuous line or filament. External level sensing can be accomplished in several ways, depending on the embodiment. A filament with increasing thickness with extremities corresponding to the extremities in the melt pool height can be used in conjunction with an ultrasonic sensor. It should be noted that alternate embodiments may include ultrasonic sensing, force measurement, or other means to detect height. Aside from thickness in the filament, the filament may be patterned, have physical flags, or other indicators such as thickness or color gradients, wherein the accompanying sensor may be visual or colorimetric. The measured thickness, whether based on a physical indicator such as filament diameter that is ramped, stepped, or transitions over a gradient would directly correspond to the pool height in the pump, as shown in FIGS. 4A and 4B. A connected tensioner apparatus would be used to maintain a constant tension in the filament leading up to the float. As line weight would be insignificant compared to the weight of the float, this would ensure control of the tension in the line. The height of the top level of the aluminum or other molten printing material in the melt pool can be maintained within a nominal range via a closed loop system connecting the printing material wire feed and the level sensing systems. The operation or method steps and apparatus described in regard to FIGS. 3A-3C and FIGS. 4A-4B illustrate the use of a control scheme that changes the level of the pump in-situ during a print job. As dross accumulation causes the laser of the level-sensor to scatter due to the rough nature of the dross surface atop the melt pool of printing material, the scattered drop-out signal prevents the sensor from reading the true height of the melt pool as the signal may become intermittent, and eventually completely drop out from the scattering. The level sensing and control methods and apparatus of the present disclosure operate independent of any reflective surface characteristic of the melt pool as required by a laser reflection based sensing and control system. Additional advantages of the present disclosure include a capability to leverage an external level sensor to predict melt pool height which is independent of the composition of the melt pool and to maintain melt pool height from passing low or high limits while continuing to use an open loop wire feed system. This may result in print run time being greatly increased before an unplanned shut-down, which allows for larger size part builds and greater productivity. Further improvements in service life of the upper pump as dross build up from longer runs may be realized which normally can ruin upper pumps.

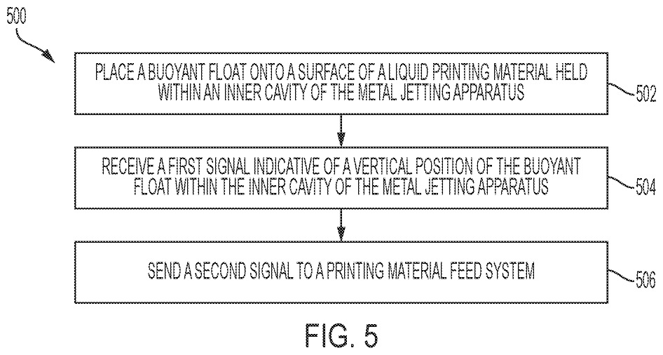

FIG. 5 is a flowchart illustrating a method of level sensing in a liquid ejector jet of a metal jetting printer, according to an embodiment. A method of sensing and controlling a level of liquid printing material in a metal jetting apparatus 500 is illustrated, which provides a method to place a buoyant float onto a surface of a liquid printing material held within an inner cavity of the metal jetting apparatus 502. The level sensing system then receives a first signal indicative of a vertical position of the buoyant float within the inner cavity of the metal jetting apparatus 504, which in turn sends a second signal to a printing material feed system 506. The method of sensing and controlling a level of liquid printing material in a metal jetting apparatus 500 may include wherein receiving the first signal is completed with a level sensing system comprising an ultrasonic sensor, a visual sensor, a mechanical force sensor, a laser sensor, or a combination thereof. Alternative embodiments of the method of sensing and controlling a level of liquid printing material in a metal jetting apparatus 500 may include adding printing material from the printing material feed system when the first signal indicates that the vertical position of the buoyant float denotes an insufficient level of liquid printing material held within the inner cavity of the metal jetting apparatus. The method of sensing and controlling a level of liquid printing material in a metal jetting apparatus 500 may include stopping an addition of printing material from the printing material feed system when the first signal indicates that the vertical position of the buoyant float denotes a sufficient level of liquid printing material held within the inner cavity of the metal jetting apparatus. Exemplary embodiments of the method of sensing and controlling a level of liquid printing material in a metal jetting apparatus 500 may also include heating a solid printing material held within the inner cavity of the metal ejecting apparatus, thereby causing the solid printing material held to change to a liquid within the metal ejecting apparatus.

In certain embodiments of the method of sensing and controlling a level of liquid printing material in a metal jetting apparatus 500, the printing material is in the form of a wire feed, while alternate embodiments may utilize printing material made from powder or liquid. The printing material may be composed of metal or metal alloys or combinations thereof as described herein, or alternatively may be composed of plastic or plastic composite materials, one or more polymers, or combinations thereof. Exemplary metal or metal alloys may include aluminum, aluminum alloys, or a combination thereof. In embodiments utilizing wire feed or externally introduced printing materials, the method may include removing the printing material feed from the reservoir or inner cavity of the ejector jet at certain times. Any and all of the steps of controlling a level of liquid printing material in a metal jetting apparatus 500 may be repeated multiple times, up to even ten times as long as the inner cavity or reservoir will accommodate additional volume and not be adversely affected by accumulated dross inside the cavity of the liquid ejector. Alternate embodiments of methods for controlling a level of liquid printing material in a metal jetting apparatus 500 may include filling an inner cavity in communication with a liquid ejector with a printing material, reading a level signal from a surface of a melt pool in the reservoir using a float sensor system as described herein, connecting the level signal generated by the float and detector in the leveling system, to the filling of the inner cavity with the printing material, pausing a jetting operation of the liquid ejector, increasing a quantity of printing material in the inner cavity until a low level signal is no longer received from the float sensor level system, and resuming the jetting operation of the liquid ejector.

The method described herein provides an advantageous, “within print-job” adjustment of a target fluid setpoint level in metal jetting printing systems. A print job may be “paused” any number of times to adjust target fluid level and may be easily implemented into standard control software for a variety of metal jet printers or printers using liquid ejectors. Employing various embodiments of this method may facilitate print run time increases without shutting down due to level-sense failures, which enables and allows for larger size part builds and longer time between pump replacements. This method should also allow for maintaining jetting performance while changing pump level and improving printing system ability to measure and control the level of the melt pool height. The method may further enable running at higher pump temperatures as well, which can lead to improved jet quality, as higher temperature setpoints may lead to faster dross accumulation.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A metal ejecting apparatus, comprising:
a structure defining an inner cavity to contain a liquid metal printing material;
a nozzle orifice in connection with the inner cavity and configured to eject one or more droplets of the liquid metal printing material;
a float in contact with a surface of the liquid metal printing material, wherein the float is buoyant within the liquid printing material; and
a filament attached to the float on a first end and attached to a level sensing system on a second end.

2. The metal ejecting apparatus of claim 1, wherein the float is hollow.

3. The metal ejecting apparatus of claim 1, wherein a density of the float is less than a density of the liquid metal printing material.

4. The metal ejecting apparatus of claim 1, wherein the float comprises boron nitride.

5. The metal ejecting apparatus of claim 1, wherein the float is non-wetting when in contact with the liquid metal printing material.

6. The metal ejecting apparatus of claim 1, wherein the float is resistant to high temperature.

7. The metal ejecting apparatus of claim 1, wherein the filament is under tension.

8. The metal ejecting apparatus of claim 1, wherein the filament comprises a material that is resistant to high temperature and non-wetting when in contact with the liquid metal printing material.

9. The metal ejecting apparatus of claim 1, wherein the filament comprises an indicating feature in one or more locations along a length of the filament.

10. The metal ejecting apparatus of claim 9, wherein the indicating feature is configured to alert the level sensing system of a low level of liquid metal printing material.

11. The metal ejecting apparatus of claim 9, wherein the indicating feature is configured to alert the level sensing system of a sufficient level of liquid metal printing material.

12. The metal ejecting apparatus of claim 1, wherein the level sensing system comprises an ultrasonic sensor, a visual sensor, a mechanical force sensor, a laser sensor, or a combination thereof.

13. A metal ejecting apparatus, comprising:
a structure defining an inner cavity to contain a liquid metal printing material;
a nozzle orifice in connection with the inner cavity and configured to eject one or more droplets of the liquid metal printing material;
a float in contact with a surface of the liquid metal printing material wherein the float is buoyant within the liquid printing material;
a filament comprising an indicating feature, attached to the float on a first end, and attached to a level sensing system; and
wherein the level sensing system is configured to receive a signal from the indicating feature.

14. The metal ejecting apparatus of claim 13, wherein:
the indicating feature is configured to alert the level sensing system of a low level of liquid metal printing material; and
the indicating feature is configured to alert the level sensing system of a sufficient level of liquid metal printing material.

15. The metal ejecting apparatus of claim 13, wherein the level sensing system comprises an ultrasonic sensor, a visual sensor, a mechanical force sensor, a laser sensor, or a combination thereof.

16. A method of sensing and controlling a level of liquid printing material in a metal jetting apparatus, comprising:
placing a buoyant float onto a surface of a liquid printing material held within an inner cavity of the metal jetting apparatus;
receiving a first signal indicative of a vertical position of the buoyant float within the inner cavity of the metal jetting apparatus; and
sending a second signal to a printing material feed system.

17. The method of sensing and controlling a level of liquid printing material in a metal jetting apparatus of claim 16, wherein receiving the first signal is completed with a level sensing system comprising an ultrasonic sensor, a visual sensor, a mechanical force sensor, a laser sensor, or a combination thereof.

18. The method of sensing and controlling a level of liquid printing material in a metal jetting apparatus of claim 16, further comprising adding printing material from the printing material feed system when the first signal indicates that the vertical position of the buoyant float denotes an insufficient level of liquid printing material held within the inner cavity of the metal jetting apparatus.

19. The method of sensing and controlling a level of liquid printing material in a metal jetting apparatus of claim 16, further comprising stopping an addition of printing material from the printing material feed system when the first signal indicates that the vertical position of the buoyant float denotes a sufficient level of liquid printing material held within the inner cavity of the metal jetting apparatus.

20. The method of sensing and controlling a level of liquid printing material in a metal jetting apparatus of claim 16, further comprising heating a solid printing material held within the inner cavity of the metal ejecting apparatus, thereby causing the solid printing material held to change to a liquid within the metal ejecting apparatus.
